(19) United States
(12) Patent Application Publication
(10) Pub. No.: US 2017/0024670 A1
(43) Pub. Date: Jan. 26, 2017

(54) SYSTEM AND METHOD FOR MANAGING EQUINE EVENTS

(71) Applicant: Cameron John Schoneberg, Cottonwood Falls, KS (US)

(72) Inventor: Cameron John Schoneberg, Cottonwood Falls, KS (US)

(21) Appl. No.: 15/284,115

(22) Filed: Oct. 3, 2016

(51) Int. Cl. G06Q 10/06; G06Q 40/00; G07F 17/32

(52) U.S. Cl. CPC G06Q 10/06313; G07F 17/3244; G06Q 40/00

(57) ABSTRACT

The embodiments herein provide a system and method for managing equine events. The participation details are collected from one or more contestants participating in the equine event using a computing device. The equine event comprises plurality of divisions separated based on a pre-determined time interval from a fastest time clocked in the event. The entry fee is received from each contestant via a payment gateway. The entry fee for each contestant is computed based on the plurality of divisions chosen by a contestant and a number of horses selected by each contestant. A preset percentage of the total amount is assigned to the promoters as a promoter share. A reward amount for each division is determined after deducting the promoter fees. A prizemoney is rewarded to one or more contestants based on ranking.

### BACKGROUND

Technical Field

The embodiments herein are generally related to equine events. The embodiments herein are particularly related to a system and method of managing equine events. The embodiments herein are more particularly related to a system and method for managing equine events foe maximizing amount paid to contestant and promotor of equine event.

Description of the Related Art

Equine events are sports events which use equines or horses as a main part of the sport. One of the most popular equine events is barrel racing which is associated with rodeo events. Barrel racing involves a contestant riding an equine in a prescribed pattern around three upright barrels. The pattern is of a cloverleaf shape or other similar configuration. The contestant riding the equine completes the pattern by running around the three barrels set up at specific distances in an arena. In order to complete the equine event, the contestant is required to circle the barrels one after the other in the cloverleaf pattern. The race begins with circling of the first barrel on the baseline of the cloverleaf pattern, followed by the next baseline barrel. Finally, the barrel at the apex is circled and the contestant crosses the finish line positioned below the base of the cloverleaf pattern.

Moreover, the equine event is a timed event and the contestant completing the equine event in the shortest time without upsetting any barrel is declared as a winner. The winning contestants are rewarded with a payout based on ranking. In order to encourage increased participation in the equine event and to improve upon the chances of more contestants getting payouts, the concept of division is introduced.

The divisions are identified as time interval slots with a difference of time from the time taken by the fastest equine contestant to complete the race. The divisions are separated by time slots or points. The divisions (also known as D races) are split using the designations 1D, 2D, 3D, 4D, 5D and so on. The first division 1D is designated by the fastest time clicked in the race. The following divisions are designated by the time slots or points. Here, 1D division is represented by the equines and contestants clocking time closest to the fastest times/winning time. Some of the well known racing associations split the divisions into time slots with a time difference such as by factors of 0.5 seconds. For example, the fastest time category is 1D while 2D is 0.5 seconds slower than the 1D time and so on.

The winners of each division are rewarded with payouts at the end of the equine event. The payout rewarded is usually variable and is decided at the beginning of the equine event. For example, in a 3D event the payout rewarded is the total amount collected as participation fees after deducting the promoter fees. The payout is distributed to the winners of each division. For example 50% of payout is rewarded to the 1^{st} division, 30% to the 2^{nd} division (0.5 second off fastest time), and 20% to the 3rd division (1 seconds off fastest time). Within each division payout is further rewarded to multiple contestant for example 60% (of 30%) to the winner of 1^{st} division and 40% to 2^{nd} winner of the 1^{st} division and so on for each division.

However, in this existing payout model, the maximum payout is awarded to the first few contestants (depending on the total number of divisions and contestants) in 1D followed by 2D and so on. Within each of the division the maximum payout is awarded to the first ranked contestant in that division followed by second ranked contestant and so on. Thus, in the current format of the game, only the first few ranked contestants get the payout. The race timing of all other contestants is either too slow for the current division or too fast for the next division. This results into a state of many contestants falling into a crack and hence not getting any payout.

The promoter share is a fixed percentage of the total amount collected from all the contestants. So, the promoter share is solely dependent on the total number of participating contestants in equine event and increases with increase in number of contestants and number of equine's. Since the number of contestants does not increase rapidly and so is the share amount for promoters. Similarly the payout for each contestant and the total number of contestants getting the payout also depends on the number of participating equines.

Hence, there is a need for a system and method to manage the barrel race or equine event for maximizing the payout of contestants and promotors by allowing more contestants to participate in a plurality of divisions of an equine event. There is also a need for a system and method for facilitating better promoter payout without increasing the number of contestants. Further, there is a need for a system and method to improve the chances of plurality of contestants in earning more payout.

The above mentioned shortcomings, disadvantages and problems are addressed herein and which will be understood by reading and studying the following specification.

### OBJECTS OF THE EMBODIMENTS

The primary object of the embodiments herein is to provide a system and method for managing equine events.

Another object of the embodiments herein is to provide a system and method for managing equine events for allowing the contestant to participate in a plurality of divisions in an equine event to maximize the prize money for contestants and promoters.

Yet another object of the embodiments herein is to provide a system and method for managing equine event or barrel racing for increasing the payout for the promoters even without increasing the number of participating equines.

Yet another object of the embodiments herein is to provide a system and method for managing equine event or barrel racing to increase the number of contestants winning the reward amount.

Yet another object of the embodiments herein is to provide a system and method for managing equine event or barrel racing for allowing same contestant to ride one or more horses/equines in the equine event by paying the participation fees for each participating horse/equine.

Yet another object of the embodiments herein is to provide a system and method for managing equine event or barrel racing for allowing one or more contestants to choose a plurality of divisions for participating by paying the participation fees for each chosen division and for each equine.

Yet another object of the embodiments herein is to provide a system and method for managing equine event or barrel racing for increasing the total reward amount for each division of the equine event.

Yet another object of the embodiments herein is to provide a system and method for managing equine event or barrel racing to retain a maximum share of the total amount paid by the contestant as part of the division in which the contestant participates and permitting the contestant to compete for maximum portion of own money paid without any loss incurred due to percentage distribution across division.

Yet another object of the embodiments herein is to provide a system and method for managing equine event or barrel racing for collecting the participation fees and for rewarding payout electronically.

Yet another object of the embodiments herein is to provide a system and method for managing equine event or barrel racing to install a software application in the computing device of the contestant for submitting participant and contesting details, and maintaining a record of the reward points earned to identify place, time and reward amount for future events.

Yet another object of the embodiments herein is to provide a system and method for managing equine event or barrel racing for allotting reward points to the contestant at the end of each equine event based on ranking.

Yet another object of the embodiments herein is to provide a system and method to provide a system and method for managing equine event or barrel racing for manually or electronically disposing payout to the one or more winning contestants in each division.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a system and method for managing equine events for increasing the money paid to the contestants and promotors by permitting the contestants to participate in a plurality of divisions and to select a plurality of horses in each division.

According to an embodiment herein, an equine event or barrel racing management system is provided. The system comprises a registration module provided in a server. The registration module is run on a hardware processor and configured for collecting contesting details from a plurality of contestants participating in an equine event or barrel racing through a computing device of the plurality of contestants. The equine event comprises a plurality of divisions which are separated by a preset time intervals or point slots from a fastest or minimum time clicked in the equine event or barrel racing. An entry fee collection module is provided in the server. The entry fee collection module is run on the hardware processor and configured for receiving an entry fee from each contestant via a payment gateway. The entry fee for each contestant is computed based on the plurality of divisions chosen by a contestant for participation, a plurality of horses selected for each division and a plurality of divisions selected for a horse in the equine event or barrel racing. A promoter share or commission amount estimation module is provided in the server. The promoter share or commission amount estimation module is run on the hardware processor and configured to estimate a preset percentage of a total amount collected as the entry fee from all the contestants, as a promoter share or commission amount. A contestant reward amount or prize money calculation module is provided in the server. The contestant reward amount or prize money calculation module is run on a hardware processor and configured for calculating a reward amount for each division after deducting the promoter share or commission amount from the collected entry fee. The reward amount for each division is calculated based on a total number of contestants participating in each division and a total number of horses or equines participating in each division. A contestant reward or prize money payment module is provided in the server. The contestant reward amount or prize money payment module is run on the hardware processor and configured for paying the contestant reward or the prizemoney to each contestant in each division based on ranking. A total number of ranks to be rewarded in each division are computed based on the total number of equines or horses participating in each division and the total number of contestants participating in each division. The reward amount or prize money given to each contestant is increased by allowing each contestant to participate in a plurality of divisions and allowing each contestant to select a plurality of horses or equines in each division.

According to an embodiment herein, the system further comprises a database configured for storing the participation details of the contestant, equine details, rewards points for each contestant, ranking of the contestants, promoter share or commission amount details and contestant reward or prize money details.

According to an embodiment herein, the contestant reward or prize money calculation module is configured to determine the reward amount or prize money for each division regardless of the number of contestants participating in other remaining divisions.

According to an embodiment herein, the registration module is configured for providing an option to a single contestant to ride one or more equines by paying the entry fee for each participating equine.

According to an embodiment herein, the registration module is configured for providing an option to a single contestant to select a plurality of divisions for participation by paying the entry fee for each selected division.

According to an embodiment herein, the plurality of participation details comprises a name of the equine event or barrel race, details of one or more horses participating in the equine event or barrel race, a plurality of divisions selected by the contestant for participation, a plurality of horses selected in a division, details of entry fees to be paid by the contestant, and details of the entry fees paid.

According to an embodiment herein, the computing device of one or more participant comprises any one of a personal computer, mobile phone, laptop, and PDA.

According to an embodiment herein, the computing device of one or more participant is installed with a software application, and wherein the software application is configured for allowing a contestant to submit the participation details, maintain a record of the reward points earned and to identify place, time and reward amount for future events.

According to an embodiment herein, the contestant reward amount or prize money payment module is run on the hardware processor and configured to pay the reward amount or prize money to one or more winning contestants in each division manually or electronically via a payment gateway.

According to an embodiment herein, a computer implemented method comprising instructions stored on a non-transitory computer readable storage medium and run a computing device provided with a hardware processor and memory for managing equine events, is provided. The method comprising the steps of collecting a plurality of participation details from one or more contestants participating in an equine event or barrel racing from a computing device of the one or more contestants with a registration module provided in a server, and wherein the equine event comprises a plurality of divisions which are separated by a preset time intervals or point slots from a fastest or minimum time clicked in the equine event or barrel racing. An entry fee is received from each contestant with an entry fee collection module provided in the server through a payment gateway. The entry fee for each contestant is computed based on the plurality of divisions chosen by a contestant for participation, a plurality of horses selected for each division and a plurality of divisions selected for a horse in the equine event or barrel racing. A preset percentage of a total amount collected as the entry fee from all the contestants is estimated as a promoter share or commission amount with a promoter share or commission amount estimation module provided in the server. A reward amount or prize money for each division is calculated after deducting the promoter share or commission amount from the collected entry fee with a contestant reward or prize money payment module provided in the server. The reward amount for each division is calculated based on a total number of contestants participating in each division and a total number of horses or equines participating in each division. The contestant reward or the prizemoney is paid to each contestant in each division based on ranking with a contestant reward or prize money payment module provided in the server. The total number of ranks to be rewarded in each division is computed based on the total number of equines or horses participating in each division and the total number of contestants participating in each division. The reward amount or prize money given to each contestant is increased by allowing each contestant to participate in a plurality of divisions and allowing each contestant to select a plurality of horses or equines in each division.

According to an embodiment herein, the plurality of participation details comprise a name of the equine event, details of one or more equines or horses participating in the equine event, a plurality of divisions chosen by the contestant for participating in the equine event, a plurality of horses selected in a division, details of entry fees to be paid by the contestant, and details of the entry fees paid.

According to an embodiment herein, a single contestant is allowed to ride one or more equines by paying the entry fee for each participating equine.

According to an embodiment herein, the one or more contestants are allowed to choose a plurality of divisions for participation by paying the entry fee for each chosen division and for each selected equine.

According to an embodiment herein, the computing device comprises any one of a personal computer, mobile phone, laptop, and PDA.

According to an embodiment herein, the contestant is assigned with reward points at the end of each equine event based on ranking, and wherein the contestant accumulating maximum reward points over a time duration gets awarded at the end of racing season.

According to an embodiment herein, the computing device is installed with a software application, and wherein the software application is configured for allowing a contestant to submit participation details, maintain a record of the reward points earned and to identify place, time and reward amount for future events.

According to an embodiment herein, the prize money is paid to the one or more winning contestants in each division by the contestant reward or prize money payment module provided in the server manually or electronically via a payment gateway.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1 illustrates a plan view of a barrel racing arena, according to one embodiment herein.

FIG. 2 illustrates a functional block diagram of the equine event management system, according to one embodiment herein.

FIG. 3 illustrates a front view of a mobile computing device displaying the software application screen used by the contestant for providing participation details such as name of the contestant, equine event selected for participation, specifying number of equines participating along with equine details, in an equine event management system, according to one embodiment herein.

FIG. 4 illustrates a front view of a mobile computing device displaying schematic representation of the software application screen used by the contestant for providing participation details such as choosing the plurality of divisions for participation for each equine, in an equine event management system according to one embodiment herein.

FIG. 5 illustrates a front view of a mobile computing device displaying schematic representation of the software application screen used by the contestant for receiving details such as participation fees to be paid, in an equine event management system according to one embodiment herein.

FIG. 6 illustrates an entry form to be filled by the contestant for providing participation details in a system for managing an equine event, according to one embodiment herein.

FIG. 7 illustrates a flow chart explaining a method of managing an equine event for maximizing a reward for one or more contestants and stake for promoters, according to one embodiment herein.

Although the specific features of the present invention are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a system and method for managing equine events for increasing the money paid to the contestants and promotors by permitting the contestants to participate in a plurality of divisions and to select a plurality of horses in each division.

According to an embodiment herein, an equine event or barrel racing management system is provided. The system comprises a registration module provided in a server. The registration module is run on a hardware processor and configured for collecting contesting details from a plurality of contestants participating in an equine event or barrel racing through a computing device of the plurality of contestants. The equine event comprises a plurality of divisions which are separated by a preset time intervals or point slots from a fastest or minimum time clicked in the equine event or barrel racing. An entry fee collection module is provided in the server. The entry fee collection module is run on the hardware processor and configured for receiving an entry fee from each contestant via a payment gateway. The entry fee for each contestant is computed based on the plurality of divisions chosen by a contestant for participation, a plurality of horses selected for each division and a plurality of divisions selected for a horse in the equine event or barrel racing. A promoter share or commission amount estimation module is provided in the server. The promoter share or commission amount estimation module is run on the hardware processor and configured to estimate a preset percentage of a total amount collected as the entry fee from all the contestants, as a promoter share or commission amount. A contestant reward amount or prize money calculation module is provided in the server. The contestant reward amount or prize money calculation module is run on a hardware processor and configured for calculating a reward amount for each division after deducting the promoter share or commission amount from the collected entry fee. The reward amount for each division is calculated based on a total number of contestants participating in each division and a total number of horses or equines participating in each division. A contestant reward or prize money payment module is provided in the server. The contestant reward amount or prize money payment module is run on the hardware processor and configured for paying the contestant reward or the prizemoney to each contestant in each division based on ranking. A total number of ranks to be rewarded in each division are computed based on the total number of equines or horses participating in each division and the total number of contestants participating in each division. The reward amount or prize money given to each contestant is increased by allowing each contestant to participate in a plurality of divisions and allowing each contestant to select a plurality of horses or equines in each division.

According to an embodiment herein, the system further comprises a database configured for storing the participation details of the contestant, equine details, rewards points for each contestant, ranking of the contestants, promoter share or commission amount details and contestant reward or prize money details.

According to an embodiment herein, the contestant reward or prize money calculation module is configured to determine the reward amount or prize money for each division regardless of the number of contestants participating in other remaining divisions.

According to an embodiment herein, the registration module is configured for providing an option to a single contestant to ride one or more equines by paying the entry fee for each participating equine.

According to an embodiment herein, the registration module is configured for providing an option to a single contestant to select a plurality of divisions for participation by paying the entry fee for each selected division.

According to an embodiment herein, the plurality of participation details comprises a name of the equine event or barrel race, details of one or more horses participating in the equine event or barrel race, a plurality of divisions selected by the contestant for participation, a plurality of horses selected in a division, details of entry fees to be paid by the contestant, and details of the entry fees paid.

According to an embodiment herein, the computing device of one or more participant comprises any one of a personal computer, mobile phone, laptop, and PDA.

According to an embodiment herein, the computing device of one or more participant is installed with a software application, and wherein the software application is configured for allowing a contestant to submit the participation details, maintain a record of the reward points earned and to identify place, time and reward amount for future events.

According to an embodiment herein, the contestant reward amount or prize money payment module is run on the hardware processor and configured to pay the reward amount or prize money to one or more winning contestants in each division manually or electronically via a payment gateway.

According to an embodiment herein, a computer implemented method comprising instructions stored on a non-transitory computer readable storage medium and run a computing device provided with a hardware processor and memory for managing equine events, is provided. The method comprising the steps of collecting a plurality of participation details from one or more contestants participating in an equine event or barrel racing from a computing device of the one or more contestants with a registration module provided in a server, and wherein the equine event comprises a plurality of divisions which are separated by a preset time intervals or point slots from a fastest or minimum time clicked in the equine event or barrel racing. An entry fee is received from each contestant with an entry fee collection module provided in the server through a payment gateway. The entry fee for each contestant is computed based on the plurality of divisions chosen by a contestant for participation, a plurality of horses selected for each division and a plurality of divisions selected for a horse in the equine event or barrel racing. A preset percentage of a total amount collected as the entry fee from all the contestants is estimated as a promoter share or commission amount with a promoter share or commission amount estimation module provided in the server. A reward amount or prize money for each division is calculated after deducting the promoter share or commission amount from the collected entry fee with a contestant reward or prize money payment module provided in the server. The reward amount for each division is calculated based on a total number of contestants participating in each division and a total number of horses or equines participating in each division. The contestant reward or the prizemoney is paid to each contestant in each division based on ranking with a contestant reward or prize money payment module provided in the server. The total number of ranks to be rewarded in each division is computed based on the total number of equines or horses participating in each division and the total number of contestants participating in each division. The reward amount or prize money given to each contestant is increased by allowing each contestant to participate in a plurality of divisions and allowing each contestant to select a plurality of horses or equines in each division.

According to an embodiment herein, the plurality of participation details comprise a name of the equine event, details of one or more equines or horses participating in the equine event, a plurality of divisions chosen by the contestant for participating in the equine event, a plurality of horses selected in a division, details of entry fees to be paid by the contestant, and details of the entry fees paid.

According to an embodiment herein, a single contestant is allowed to ride one or more equines by paying the entry fee for each participating equine.

According to an embodiment herein, the one or more contestants are allowed to choose a plurality of divisions for participation by paying the entry fee for each chosen division and for each selected equine.

According to an embodiment herein, the computing device comprises any one of a personal computer, mobile phone, laptop, and PDA.

According to an embodiment herein, the contestant is assigned with reward points at the end of each equine event based on ranking, and wherein the contestant accumulating maximum reward points over a time duration gets awarded at the end of racing season.

According to an embodiment herein, the computing device is installed with a software application, and wherein the software application is configured for allowing a contestant to submit participation details, maintain a record of the reward points earned and to identify place, time and reward amount for future events.

According to an embodiment herein, the prize money is paid to the one or more winning contestants in each division by the contestant reward or prize money payment module provided in the server manually or electronically via a payment gateway.

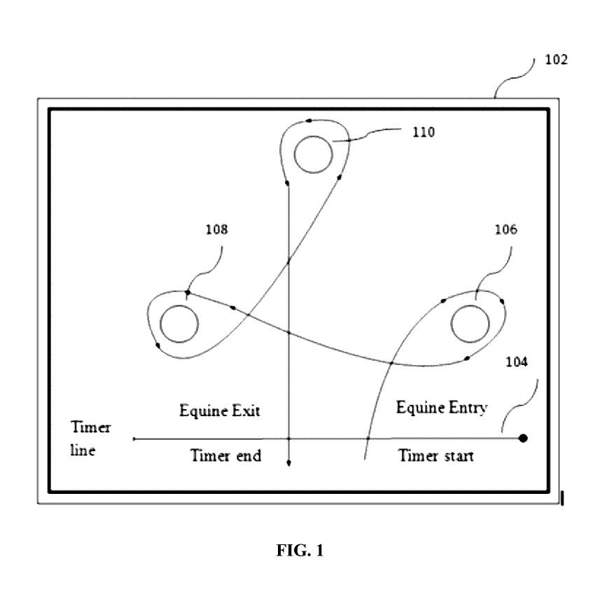

FIG. 1 illustrates a plan view of a barrel racing arena, according to one embodiment herein. With respect to FIG. 1, the equine event arena 102 is arranged in a cloverleaf shaped pattern. A contestant enters the arena at a timer line 104 to begin the race. The race proceeds with circling around the first barrel 106, the second barrel 108, and then continues on to the third barrel 110 to complete the pattern. Finally the arena is exited by crossing the timer line 104 for a second time. This pattern is often referred to as a “Cloverleaf”. In some cases, the pattern also begins with circling of the second barrel 108 first and then the first barrel 106. The equine event comprises plurality of divisions determined by the speed an equine runs the cloverleaf pattern. The overall fastest time clocked in the race is used to set the time slots or intervals for the divisions.

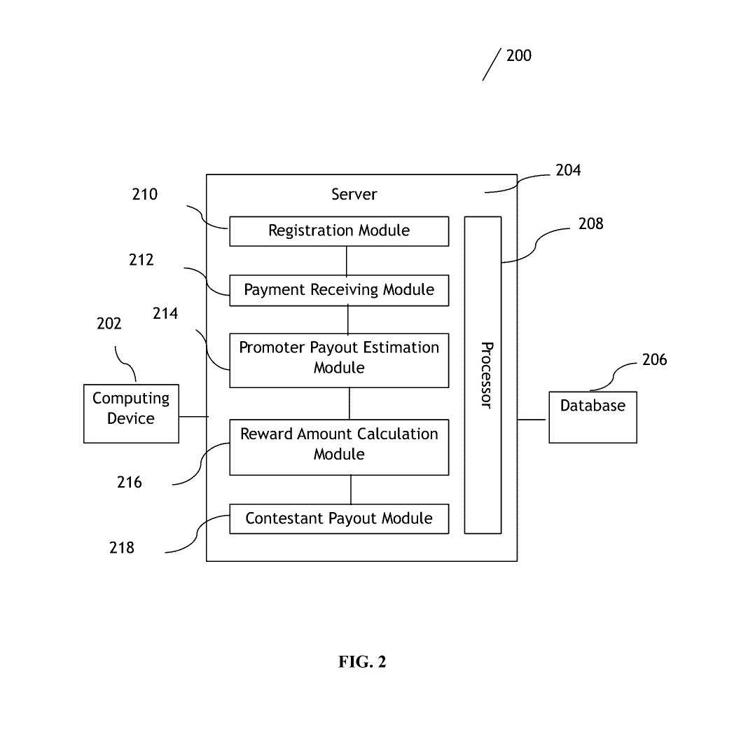

FIG. 2 illustrates a functional block diagram of the equine event management system, according to one embodiment herein. The system comprises the computing device 202, server 204 and database 206. The server 204 comprises the processor 208, the registration module 210, the payment receiving module 212, promoter payout estimation module 214, reward amount calculation module 216 and contestant payout module 218.

According to an embodiment herein, a plurality of participation details from one or more contestants participating in the equine event are collected using the computing device 202. The computing device comprises a personal computer, mobile phone, laptop, PDA, and the like.

According to an embodiment herein, the server 204 comprises a processor 208 configured for processing the requests received from the registration module 210, a payment receiving module 212, promoter payout estimation module 214, reward amount calculation module 216 and contestant payout module 218 and interacts with the database 206. The registration module 210 is configured for registering one or more contestants with the equine event management system 200 and for storing the participation details of all the contestants and the participating equines into the database 206.

According to an embodiment herein, the payment receiving module 212 is connected to the registration module 210 and is configured for receiving the participation fees from each contestant. The participation fee for each contestant is computed based on the plurality of divisions chosen by a contestant for participating in the event. On successful payment of the participation fees by the contestant, the registration is completed.

According to an embodiment herein, the promoter payout estimation module 214 is connected to the payment receiving module 212 and is configured for estimating the payout for the promoter of the equine event. A pre-decided percentage share of the total amount collected as the participation fees from all the contestants is assigned to the promoters as a promoter fee.

According to an embodiment herein, the reward amount calculation module 216 is connected to the promoter payout estimation module 214 and is configured for calculating the reward amount for each division. The reward amount for each division is estimated based on total number of equines participating in that division. The reward amount for each division is computed without depending on the number of contestants participating in remaining other divisions.

According to an embodiment herein, the contestant payout module 218 is connected to the reward amount calculation module 216 and is configured for initiating payout for each winning contestant based on a ranking. The payment is made to the one or more winning contestants in each division manually or electronically via a payment gateway.

According to an embodiment herein, the computing device 202 used for providing the participation details is configured for providing a software application to the contestant. The software application is configured for allowing a contestant to submit participation details, maintain a record of the reward points earned and to identify place, time and reward amount for future events.

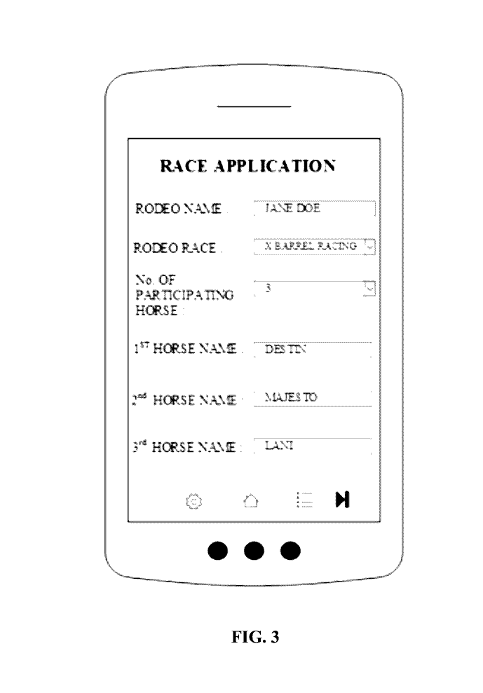

FIG. 3 illustrates a schematic representation of the software application screen used by the contestant for providing participation details such as name of the contestant, equine event selected for participation, specifying number of equines for participation with equine details, according to one embodiment herein. With respect to FIG. 3, the contestant provides participation details such as name of the contestant, equine event selected for participation and number of equines for participation with equine details by filling up the entry form at the beginning of the equine event.

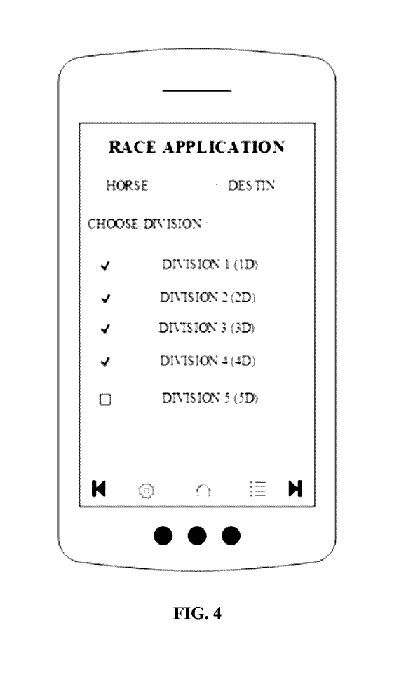

FIG. 4 illustrates a schematic representation of the software application screen used by the contestant for providing participation details such as choosing the plurality of divisions for participation, according to one embodiment herein. With respect to FIG. 4, the contestant specifies the chosen divisions and chosen equines to participate in the equine event through an entry form at the beginning of the each equine event.

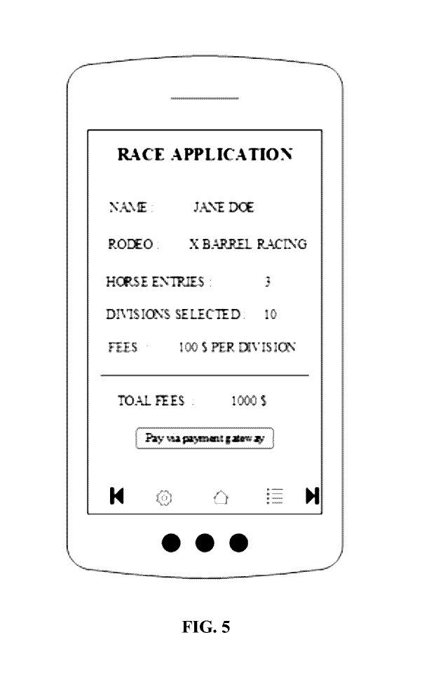

FIG. 5 illustrates a schematic representation of the software application screen used by the contestant for providing participation details such as participation fees, according to one embodiment herein. With respect to FIG. 5, the total participation fee to be paid by the contestant is displayed at the beginning of the equine event.

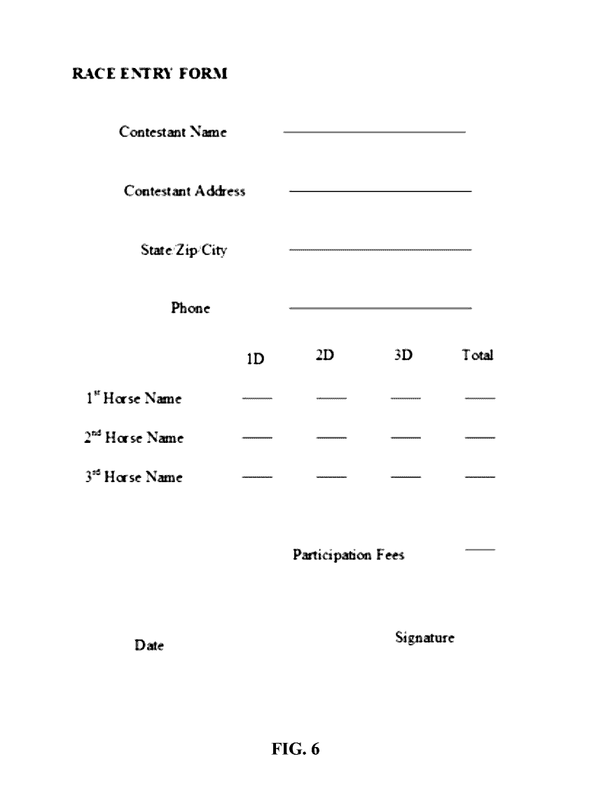

FIG. 6 illustrates an entry form available in a printed format to be filled by the contestant for providing participation details, according to one embodiment herein. With respect to FIG. 6, the contestant provides the participation details such as contestant name, contestant address, name of the equines participating in the race and divisions selected for each equine by filling up the entry form available in a printed format.

There are several formats used for providing the participation details depending on the terms and conditions of the main association conducting the equine events.

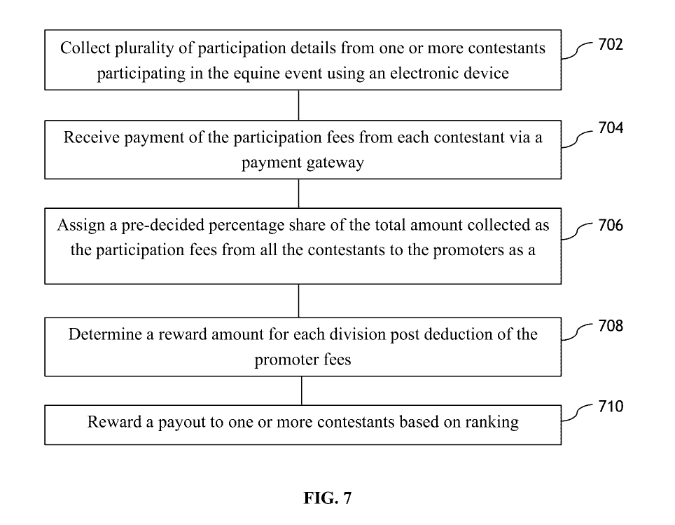

FIG. 7 illustrates a flow chart explaining a method for managing an equine event, according to one embodiment herein. According to one embodiment herein, the method comprises collecting a plurality of participation details from one or more contestants participating in the equine event using a computing device (702). The plurality of participation details comprise a name of the equine event, details of one or more equines participating in the event, a plurality of divisions selected by the one or more contestants for participating in one equine event, details of the entry fees to be paid by the contestant, details of the entry fees paid and the like.

The computing device used for providing the participation details comprises a personal computer, mobile phone, laptop, PDA, etc. According to one embodiment herein, the participation details are also furnished and submitted by the contestant through filling of an entry form available in a printed format or through an interface displayed in the computing device.

According to one embodiment herein, the equine event comprises plurality of divisions which are separated by a pre-determined time interval or points from a fastest or minimum time clocked in the equine event. The overall fastest time of the race is used to set the time intervals or time slots for the each division in the plurality of divisions. For example, the divisions are split into categories such as 1D, 2D, 3D, 4D, 5D and so on that are determined by a time difference such as by a factors of 0.5 seconds. 1D division is represented by the equines and contestants with the fastest time. In this example, the fastest time category is 1D while 2D is 0.5 seconds slower than the 1D time and so on.

According to an embodiment herein, the entry fee is received from each contestant via a payment gateway (704). The entry fee for each contestant is computed based on the plurality of divisions chosen by a contestant and the plurality of horses selected by the contestant in the equine event. The one or more contestants are allowed to choose a plurality of divisions for participating in the event by paying the entry fees for each chosen division. The contestant selects the plurality of divisions based on self-assessment and past records. The division in which a contestant normally falls in is determined/estimated based on a history of contestants in prior equine events or with the available timing data of previous equine events. The probability or chances of a contestant falling in one of the selected divisions is more than that a single division. A single contestant is allowed to ride one or more equines by paying the entry fees for each selected division or equine.

According to an embodiment herein, a predetermined or preset percentage of the total amount collected as the entry fees from all the contestants is assigned to the promoters as a promoter share or commission amount at the beginning of the equine event (706). The equine events conducted by the subsidiaries of the main association conducting the equine events need to pay the main association up to 10% of total entries paid. This is set up by contract prior to equine events.

According to an embodiment herein, a reward amount for each division is determined after deducting the promoter share or commission amount for the total entry fee collected (708). The reward amount/prize money for each division is calculated based on total number of equines and total number of contestants participating in a division. The reward amount for each division is computed without depending on the number of contestants participating in other divisions. According to one embodiment herein, a minimum of 80% of all the entry fees collected from all the contestants is considered as the reward amount or prize money. Thus, a maximum of 20% (or in some cases a maximum of 30%) is withheld for the promoter share/commission or office/administration costs.

According to one embodiment herein, the numbers of contestants in the equine event are 60 and the entry fee per equine is $50. According to an embodiment herein, the numbers of participating equines are 90 whereas the number of entries for 1D, 2D, 3D & 4D are 33, 25, 30, and 35 respectively. The total reward amount per division is a multiplication factor of participation fees with number of participating equine in that division. Based on this calculation the reward amount for 1D, 2D, 3D & 4D are $1650, $1250, $1500 and $1750 respectively. Thus, the reward amount for each division is increased as more number of contestants choose multiple divisions per equine to improve upon the chances of winning. As evident from the above calculation, the total reward amount $6150 (sum of $1650, $1250, $1500 & $1750) is higher as compared to conventional methods which is $4500 (multiplication factor of participation fees $50 & total number of participating equine 90). As mentioned earlier, the promoter share is 20% of the entry fees. Thus, the promoter share is calculated as $1230 (20% of $6150) and the share is also increased from $900 (20% of $4500) as compared to conventional method of calculation.

According to an embodiment herein, a prize money is rewarded to one or more contestants based on ranking (710). The prize money is distributed to the one or more winning contestants in each division manually or electronically via a payment gateway. The total numbers of ranks to be rewarded are predetermined based on the total number of equines participating in a division and total number of contestants participating in a division. The prize money is solely dependent on the division and rank procured by the contestant at the end of the equine event. Each contestant is allowed to choose any number of divisions for each equine. In case the contestant fails to enter the chosen division then the prize money is not rewarded to that contestant and the same amount goes to the contestant next on the list.

According to an embodiment herein, the contestant is awarded or assigned with reward points at the end of each equine event based on ranking. The contestant accumulating maximum reward points over a time duration gets awarded at the end of racing season. Further, the contestants earning more reward points than a preset number of points at the end of racing season are allowed to take part in the finale event that happens at the end of each racing season.

Thus the method allows a single contestant to participate in a plurality of divisions thereby increasing a chance of getting the prize money for the contestant. As every contestant opts for more than one division to maximize the chances of getting the prize money thereby increasing the prize money.

Also, the method is beneficial to the contestants as nearly 80% of the entry fees (left after deduction of promoter fees) paid by the contestant is considered as a part of reward amount for that division as compared to conventional method wherein the 80% entry fees is distributed in percentages across the plurality of divisions. Due to the fact that the total amount paid by the contestant remains with the division in which the contestant participates, the contestant always competes for a maximum portion of own money paid without any loss which is incurred due to percentage distribution across the plurality of divisions in a conventional method.

Further, a single contestant choosing a plurality of divisions to increase the total amount of the equine event thereby also increasing a promoter share or commission amount increases. Therefore, the method provides an increased promoter share without increasing the number of contestants.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. An equine event or barrel racing management system comprising:
a registration module provided in a server, and wherein the registration module is run on a hardware processor and configured for collecting contesting details from a plurality of contestants participating in an equine event or barrel racing through a computing device of the plurality of contestants, and wherein the equine event comprises a plurality of divisions which are separated by a preset time intervals or point slots from a fastest or minimum time clicked in the equine event or barrel racing;
an entry fee collection module provided in the server, and wherein the entry fee collection module is run on the hardware processor and configured for receiving an entry fee from each contestant via a payment gateway, and wherein the entry fee for each contestant is computed based on the plurality of divisions chosen by a contestant for participation, a plurality of horses selected for each division and a plurality of divisions selected for a horse in the equine event or barrel racing;
a promoter share or commission amount estimation module provided in the server, and wherein the promoter share or commission amount estimation module is run on the hardware processor and configured to estimate a preset percentage of a total amount collected as the entry fee from all the contestants, as a promoter share or commission amount;
a contestant reward amount or prize money calculation module provided in the server, and wherein the contestant reward amount or prize money calculation module is run on a hardware processor and configured for calculating a reward amount for each division after deducting the promoter share or commission amount from the collected entry fee, and wherein the reward amount for each division is calculated based on a total number of contestants participating in each division and a total number of horses or equines participating in each division; and
a contestant reward or prize money payment module provided in the server, and wherein the contestant reward amount or prize money payment module is run on the hardware processor and configured for paying the contestant reward or the prizemoney to each contestant in each division based on ranking, and wherein a total number of ranks to be rewarded in each division are computed based on the total number of equines or horses participating in each division and the total number of contestants participating in each division;
wherein the reward amount or prize money given to each contestant is increased by allowing each contestant to participate in a plurality of divisions and allowing each contestant to select a plurality of horses or equines in each division.

2. The system according to claim 1 further comprises a database configured for storing the participation details of the contestant, equine details, rewards points for each contestant, ranking of the contestants, promoter share or commission amount details and contestant reward or prize money details.

3. The system according to claim 1, wherein the contestant reward or prize money calculation module is configured to determine the reward amount or prize money for each division regardless of the number of contestants participating in other remaining divisions.

4. The system according to claim 1, wherein the registration module is configured for providing an option to a single contestant to ride one or more equines by paying the entry fee for each participating equine.

5. The system according to claim 1, wherein the registration module is configured for providing an option to a single contestant to select a plurality of divisions for participation by paying the entry fee for each selected division.

6. The system according to claim 1, wherein the plurality of participation details comprises a name of the equine event or barrel race, details of one or more horses participating in the equine event or barrel race, a plurality of divisions selected by the contestant for participation, a plurality of horses selected in a division, details of entry fees to be paid by the contestant, and details of the entry fees paid.

7. The system according to claim 1, wherein the computing device of one or more participant comprises any one of a personal computer, mobile phone, laptop, and PDA.

8. The system according to claim 1, wherein the computing device of one or more participant is installed with a software application, and wherein the software application is configured for allowing a contestant to submit the participation details, maintain a record of the reward points earned and to identify place, time and reward amount for future events.

9. The system according to claim 1, wherein the contestant reward amount or prize money payment module is run on the hardware processor and configured to pay the reward amount or prize money to one or more winning contestants in each division manually or electronically via a payment gateway.

10. A computer implemented method comprising instructions stored on a non-transitory computer readable storage medium and run a computing device provided with a hardware processor and memory for managing equine events, the method comprising the steps of:
collecting a plurality of participation details from one or more contestants participating in an equine event or barrel racing from a computing device of the one or more contestants with a registration module provided in a server, and wherein the equine event comprises a plurality of divisions which are separated by a preset time intervals or point slots from a fastest or minimum time clicked in the equine event or barrel racing;
receiving entry fee from each contestant with an entry fee collection module provided in the server through a payment gateway, and wherein the entry fee for each contestant is computed based on the plurality of divisions chosen by a contestant for participation, a plurality of horses selected for each division and a plurality of divisions selected for a horse in the equine event or barrel racing;
estimating a preset percentage of a total amount collected as the entry fee from all the contestants, as a promoter share or commission amount with a promoter share or commission amount estimation module provided in the server;
calculating a reward amount or prize money for each division after deducting the promoter share or commission amount from the collected entry fee with a contestant reward or prize money payment module provided in the server, and wherein the reward amount for each division is calculated based on a total number of contestants participating in each division and a total number of horses or equines participating in each division; and
paying the contestant reward or the prizemoney to each contestant in each division based on ranking with a contestant reward or prize money payment module provided in the server, and wherein a total number of ranks to be rewarded in each division are computed based on the total number of equines or horses participating in each division and the total number of contestants participating in each division;
wherein the reward amount or prize money given to each contestant is increased by allowing each contestant to participate in a plurality of divisions and allowing each contestant to select a plurality of horses or equines in each division.

11. The method according to claim 10, wherein the plurality of participation details comprise a name of the equine event, details of one or more equines or horses participating in the equine event, a plurality of divisions chosen by the contestant for participating in the equine event, a plurality of horses selected in a division, details of entry fees to be paid by the contestant, and details of the entry fees paid.

12. The method according to claim 10, wherein a single contestant is allowed to ride one or more equines by paying the entry fee for each participating equine.

13. The method according to claim 10, wherein the one or more contestants are allowed to choose a plurality of divisions for participation by paying the entry fee for each chosen division and for each selected equine.

14. The method according to claim 10, wherein the computing device comprises any one of a personal computer, mobile phone, laptop, and PDA.

15. The method according to claim 10, wherein the contestant is assigned with reward points at the end of each equine event based on ranking, and wherein the contestant accumulating maximum reward points over a time duration gets awarded at the end of racing season.

16. The method according to claim 10, wherein the computing device is installed with a software application, and wherein the software application is configured for allowing a contestant to submit participation details, maintain a record of the reward points earned and to identify place, time and reward amount for future events.

17. The method according to claim 10, wherein the prize money is paid to the one or more winning contestants in each division by the contestant reward or prize money payment module provided in the server manually or electronically via a payment gateway.
